(19) United States
(12) Patent Application Publication
(10) Pub. No.: US 2023/0082863 A1
(43) Pub. Date: Mar. 16, 2023

(54) BUBBLE GENERATING DEVICE

(71) Applicant: Wen-Tsu SU, Taipei City (TW)

(72) Inventor: Wen-Tsu SU, Taipei City (TW)

(21) Appl. No.: 17/476,900

(22) Filed: Sep. 16, 2021

(51) Int. Cl. B01F 5/04; B01F 3/04

(52) U.S. Cl. CPC B01F 5/0415; B01F 3/04503; B01F 2003/04851

(57) ABSTRACT

A bubble generating device includes a casing unit, a gas intake unit and a liquid input unit. The casing unit includes a flow passage converging from a first casing end towards a second casing end. The gas intake unit includes a mounting part mounted to the first casing end, a protrusion projecting and tapering from the mounting part into the flow passage, and a gas channel extending through the mounting part and protrusion and communicates with the flow passage. The liquid input unit includes a liquid channel communicating with the flow passage and defines an axis nonparallel to and radially offset from an axis of the flow passage.

### FIELD

The disclosure relates to a bubble generating device.

### BACKGROUND

Referring to FIG. 1, as disclosed in Taiwanese Patent No. 366696, a jet type bubble generating machine includes a casing 11, a motor 12 disposed on a rear end of the casing 11, a jet tube unit 13 disposed on a front end of the casing 11, multiple cutting webs 14 disposed in the jet tube unit 13, and an air-conducting tube 15 disposed on a top end of the casing 11. The jet tube unit 13 includes a flow passage 131 diverging away from the casing 11. The water is pumped by the motor 12 and flows into the flow passage 131 through the casing 11. When the water is guided by the flow passage 131 to generate a vortex, the air is sucked into the flow passage 131 through the air-conducting tube 15 so as to be mixed with the water for producing bubbles.

However, a length of the jet tube unit 13 is too long. The jet type bubble generating machine occupies a large space. Further, because the cutting webs 14 are disposed in the jet tube unit 13, impurities easily clog up the cutting webs 14 and need to be regularly cleaned.

### SUMMARY

Therefore, an object of the disclosure is to provide a bubble generating device that can alleviate at least one of the drawbacks of the prior art.

According to the disclosure, a bubble generating device includes a casing unit, a gas intake unit, and a liquid input unit.

The casing unit includes a first casing end, a second casing end opposite to the first casing end, and a flow passage converging from the first casing end towards the second casing end to allow a fluid to flow in a flowing direction from the first casing end to the second casing end.

The gas intake unit includes a mounting part mounted to and closing the first casing end, a protrusion projecting and tapering from the mounting part into the flow passage, and a gas channel extending through the mounting part and the protrusion. The gas channel communicates with the flow passage for introducing the gas into the flow passage.

The liquid input unit is connected to the casing unit and includes a liquid channel communicating with the flow passage for introducing the liquid into the flow passage.

### BRIEF DESCRIPTION OF THE DRAWINGS

Other features and advantages of the disclosure will become apparent in the following detailed description of the embodiment with reference to the accompanying drawings, of which:

FIG. 1 is a sectioned view of a jet type bubble generating machine;

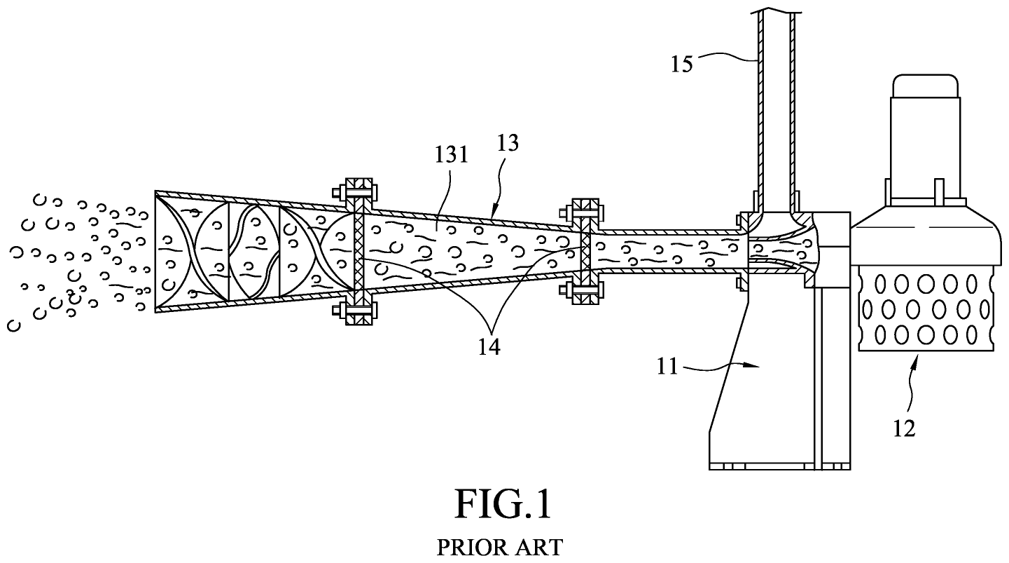

FIG. 2 is an exploded perspective view illustrating a bubble generating device according to an embodiment of the disclosure;

FIG. 3 is a top view of the embodiment;

FIG. 4 is a sectioned view taken along line VI-VI of FIG. 3; and

FIG. 5 is a front view of the embodiment illustrating a perforated plate unit of the bubble generating device.

### DETAILED DESCRIPTION

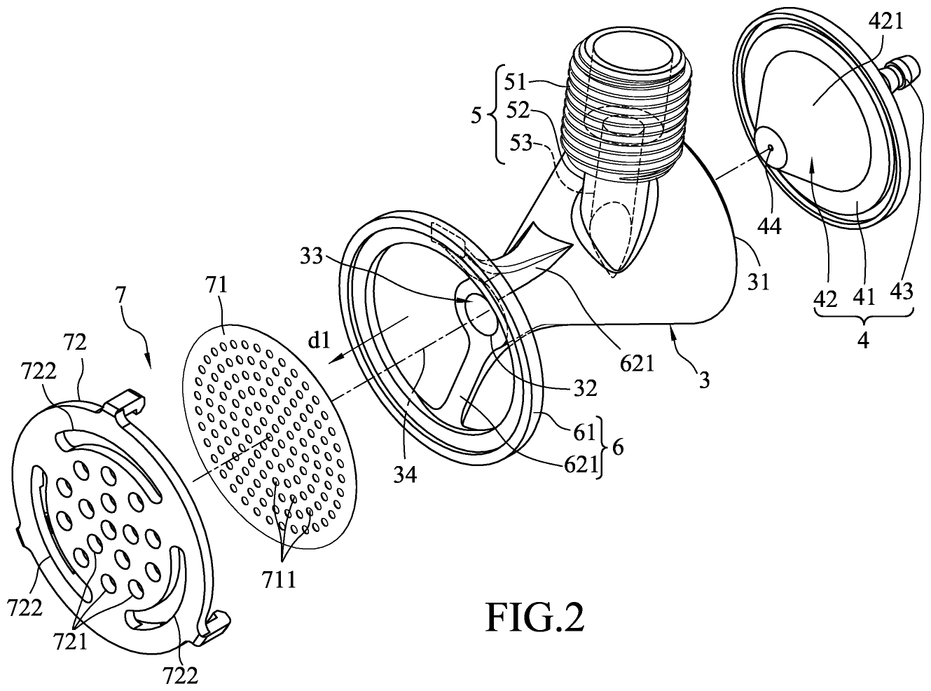

FIGS. 2 to 4 illustrate a bubble generating device according to an embodiment of the disclosure for generating bubbles by mixing a gas 22 and a liquid 21. The bubble generating device includes a casing unit 3, a gas intake unit 4, a liquid input unit 5, a support unit 6, and a perforated plate unit 7. The gas 22 may be air, and the liquid 21 may be water.

The casing unit 3 includes a first casing end 31, a second casing end 32 opposite to the first casing end 31, and a flow passage 33 converging from the first casing end 31 towards the second casing end 32 to allow a fluid to flow in a flowing direction (d1) from the first casing end 31 to the second casing end 32.

The flow passage 33 has a converging section 35, a constricted uniform width section 36, and a passage central axis 34 passing through the converging section 35 and the constricted uniform width section 36 along the flowing direction β(d1).

The converging section 35 has a substantially frustoconical cross section and tapers from the first casing end 31 toward the second casing end 32. The length (L11) thereof is 3.1 cm. An angle (A1) of 23.7 degrees is formed between a boundary wall of the converging section 35 and the passage central axis 34. The converging section 35 is the largest at the first casing end 31 and opens at the first casing end 31. In this embodiment, the diameter (D11) of the first casing end 31 is 3.8 cm. The diameter (D12) at a smallest end of the converging section 35 is 0.778 cm. In other embodiments, the angle (A1) may range between 18 and 30 degrees.

The constricted uniform width section 36 has a substantially cylindrical cross section, and a length (L12) of the constricted uniform width section 36 is measured from a smallest end of the converging section 35 to the second casing end 32. In this embodiment, the length (L12) is 1.0 cm. The constricted uniform width section 36 has a diameter (D21) of 0.778 cm.

The gas intake unit 4 includes a mounting part 41, a protrusion 42, a gas channel 44, and a connection tube 43. The mounting part 41 is mounted to and closes the first casing end 31. The protrusion 42 projects and tapers from the mounting part 41 into the flow passage 33. The gas channel 44 extends through the mounting part 41 and the protrusion 42, and communicates with the flow passage 33 for introducing the gas 22 into the flow passage 33. The connection tube 43 projects from the mounting part 41 opposite to the first casing ends 31 and communicates with the gas channel 44. An air supply tube 91 is sleeved on the connection tube 43.

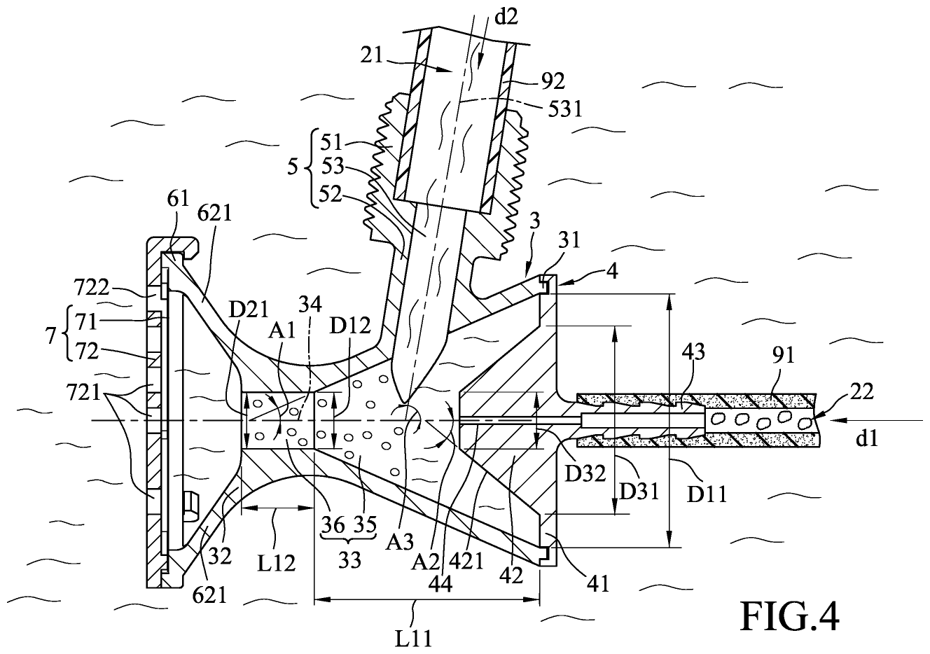

As shown in FIG. 4, the protrusion 42 has a substantially frustoconincal shape and includes a large diameter (D31) of 2.6 cm proximate to the mounting part 41 and a small diameter (D32) of 0.78 cm opposite to the mounting part 41. In this embodiment, the protrusion has an outer frustoconical surface 421 inclined at an angle (A2) of 39.6 degrees relative to the passage central axis 34. In other embodiments, the angle (A2) may range between 34 and 42 degrees.

The liquid input unit 5 is tubular, and includes a narrowed tube portion 52, a widened portion 51 and a liquid channel 53. The narrowed tube portion 52 is integrally connected to the casing unit 3. The widened tube portion 51 is connected to the narrowed tube portion 52 opposite to the casing unit 3. The liquid channel 53 extends through the narrowed and widened tube portions 52, 51 and communicates with the flow passage 33 for introducing the liquid 21 into the flow passage 33. The liquid channel 53 has an open end proximate to the protrusion 42. In other embodiment, the liquid input unit 5 may be snappingly engaged to the casing unit 3.

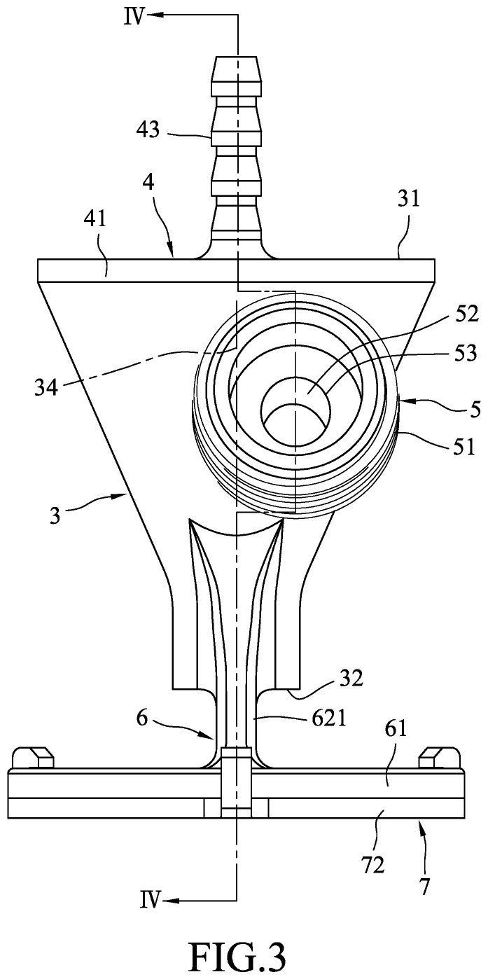

Referring back to FIGS. 3 and 4, a direction (d2) of a liquid feed flow in the liquid channel 53 is inclined to the flowing direction (d1) in the flow passage 33. The liquid channel 53 has a channel central axis 531 that is non-parallel to and radially offset from the passage central axis 34 of the flow passage 33. The direction (d2) is inclined to the flowing direction (d1) by an inclined angle (A3) of 81 degrees therebetween. In other embodiments, the inclined angle (A3) may range between 75 and 88 degrees.

The support unit 6 integrally connects and projects outwardly from the second casing end 32 in the flowing direction (d1) of the flow passage 33, and includes a mounting ring 61, and a plurality of spaced apart ribs 621, specifically two ribs 621. The mounting ring 61 is spaced apart from the second casing end 32. The two ribs 621 connect the mounting ring 61 to the second casing end 32. In other embodiment, the support unit 6 may be snappingly engaged to the casing unit 3.

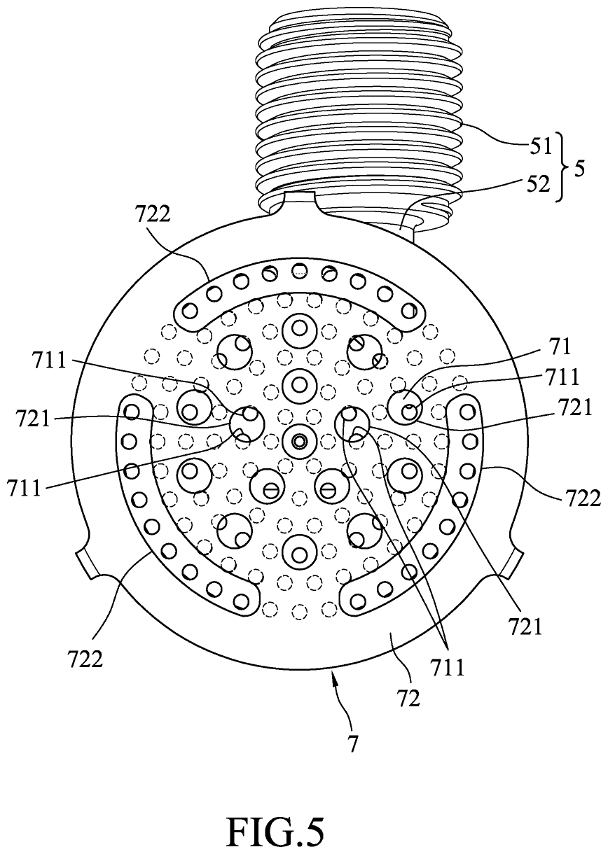

Referring back to FIGS. 2, 4 and 5, the perforated plate unit 7 is mounted to the mounting ring 61 and spaced apart from the second casing end 32. The perforated plate unit 7 includes first and second perforated plates 71, 72 stacked one over the other along the flowing direction (D1). The first perforated plate 71 has a plurality of first holes 711 equal in diameter. The second perforated plate 72 is downstream of the first perforated plate 71 and has a plurality of second holes 721 and a plurality of curved openings 722. The second holes 721 and the curved openings 722 are larger in size than the first holes 711. Some second holes 721 are staggered with the first holes 711; some second holes 721 overlap with the first holes 711. The curved openings 722 are equiangularly spaced apart from each other. Some curved openings 722 are aligned with the first holes 711, and some curved openings 722 are staggered with the first holes 711.

As shown in FIG. 4, in use, a liquid conduit 92 is inserted into the widened portion 51 of the liquid unit 5. When the liquid 21 is introduced through the liquid conduit 92 into the flow passage 33 and when the gas 22 is introduced into the flow passage 33 through the gas channel 44, a pressure difference between the converging section 35 and the constricted uniform width section 36 is generated. The pressure difference draws the gas 22 to mix with the liquid 21, thus forming bubbles in the liquid 21.

The protrusion 42 serves as a guide to help whirling of the liquid, thereby increasing the whirling effect of the liquid 21. Therefore, although a total length of the flow passage 33 is only 4.1 cm, by virtue of the protrusion 42, a sufficient fluid force can be generated in the flow passage 33 to mix the gas 22 with the liquid 21 for producing sufficient bubbles. In this embodiment, the protrusion 42 has a frustoconical shape that has an excellent effect to produce a vortex flow. However, the protrusion 42 may also have a pyramidal shape with a polygonal base such as a three-sided, four-sided or five-sided base.

Because the direction (d2) of the liquid in the liquid channel 53 is inclined to the flowing direction (d1) in the flow passage 33 and because the channel central axis 531 of the liquid channel 53 is eccentrically offset from the passage central axis 34 of the flow passage 33, when the liquid 21 is introduced into the flow passage 33, a vortical force of the liquid 21 and the gas 22 is increased in the flow passage 33 to enhance the outlet flow rate of the liquid 21 and the gas 22 and the producing efficiency of bubbles.

Referring back to FIGS. 2, 4 and 5, the constricted uniform section 36 enables the bubbles formed in the converging section 35 to break into smaller bubbles. Because the second holes 721 are staggered with and different in size from the first holes 711, when the bubbles from the constricted uniform section 36 pass through the first and second perforated plates 71, 72, they will hit the perforated plate unit 7 and the size thereof will therefore be reduced further. Because the perforated plate unit 7 is mounted to the support unit 6 and is spaced apart from the casing unit 3, impurities can be discharged between the perforated plate unit 7 and the casing unit 3 through gaps formed between the ribs 621 of the support unit 6. Thus, the perforated unit 7 is prevented from being clogged by the impurities. According to some other embodiments, the constricted uniform section 36 may be omitted.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A bubble generating device for generating bubbles by mixing a gas and a liquid, comprising:
a casing unit including a first casing end, a second casing end opposite to said first casing end, and a flow passage converging from said first casing end towards said second casing end to allow a fluid to flow in a flowing direction from said first casing end to said second casing end;
a gas intake unit including a mounting part mounted to and closing said first casing end, a protrusion projecting and tapering from said mounting part into said flow passage, and a gas channel extending through said mounting part and said protrusion, said gas channel communicating with said flow passage for introducing the gas into said flow passage; and
a liquid input unit connected to said casing unit and including a liquid channel communicating with said flow passage for introducing the liquid into said flow passage.

2. The bubble generating device as claimed in claim 1, wherein said protrusion has a frustoconical shape.

3. The bubble generating device as claimed in claim 1, wherein said flow passage has a converging section tapering from said first casing end toward said second casing end, and a constricted uniform width section extending from said converging section to said second casing end.

4. The bubble generating device as claimed in claim 3, wherein said converging section is the largest at said first casing end and opens at said first casing end, said constricted uniform width section having a length of uniform width that is measured from a smallest end of said converging section to said second casing end.

5. The bubble generating device as claimed in claim 1, further comprising a support unit and a perforated plate unit, said support unit projecting outwardly in the flowing direction from said second casing end, said perforated plate unit being mounted on said support unit and spaced apart from said second casing end.

6. The bubble generating device as claimed in claim 5, wherein said support unit includes a mounting ring spaced apart from said second casing end for mounting said perforated plate unit, and a plurality of spaced apart ribs connecting said mounting ring to said second casing end.

7. The bubble generating device as claimed in claim 6, wherein said perforated plate unit includes first and second perforated plates stacked one over the other along the flowing direction, said first perforated plate having a plurality of first holes, said second perforated plate having a plurality of second holes staggered with said first holes.

8. The bubble generating device as claimed in claim 7, wherein said second holes are larger in size than said first holes.

9. The bubble generating device as claimed in claim 1, wherein a direction of a liquid feed flow in said liquid channel is inclined to the flowing direction.

10. The bubble generating device as claimed in claim 9, wherein:
said flow passage has a passage central axis extending along the flowing direction; and
said liquid channel has a channel central axis 531 that is non-parallel to and radially offset from said passage central axis of said flow passage.
